(19) United States
(12) Patent Application Publication
(10) Pub. No.: US 2010/0096395 A1
(43) Pub. Date: Apr. 22, 2010

(54) Degradable Beverage Container Lid

(75) Inventor: Marcel Miller, Hong Kong (CN)

Correspondence Address: John Karl Buche;BUCHE & ASSOCIATES, P.C., 875 PROSPECT, SUITE 305, LA JOLLA, CA, 92037, US

(73) Assignee: MINT Urban Technologies Limited, Hong Kong (CN)

(21) Appl. No.: 12/580,897

(22) Filed: Oct. 16, 2009

(30) Foreign Application Priority Data
Oct. 16, 2008 (AU) 2008905344
Oct. 16, 2009 (IB) PCT/IB2009/007143

(51) Int. Cl. A47G 19/22; B29C 47/00; A23B 7/16

(52) U.S. Cl. 220/711; 264/210.6; 523/100

(57) ABSTRACT

The present application is directed to a beverage container lid comprising a polymeric material and a pro-degradant additive in an amount from about 0.5% to about 5.0% by weight of the lid.

### CROSS-REFERENCE TO RELATED APPLICATIONS

The present application claims the benefit of Australian provisional patent application No. 2008905344, filed Oct. 16, 2008. This application is also the U.S. national stage filing of PCT/IB2009/007143 filed with the international bureau of WIPO on Oct. 16, 2009. Both of the identified documents are hereby incorporated by reference.

### STATEMENT REGARDING FEDERALLY SPONSORED RESEARCH OR DEVELOPMENT

N/A

### FIELD OF THE INVENTION

The application relates generally to degradable beverage container lids constructed from one or more polymeric materials.

### BACKGROUND OF THE INVENTION

Single-use and disposable beverage container lids are well known. Commercially, these types of lids are typically constructed from conventional plastic materials effective for providing structural strength and rigidness, especially when used in connection with hot beverages like coffee. Although popular, plastics are not typically regarded as biodegradable—resulting in beverage container lids that take decades to degrade following their commercial use. As a result, lids made from more environmentally friendly alternative materials have been attempted. For instance, lids have been made from materials such as corn derived polyactide and starch derived polymers. However, these types of materials are undesirable because their associated strength is often times compromised when exposed to the heat and/or moisture that is emitted from the beverage housed within the corresponding container.

As it is desirable to use conventional plastics in the production of single-use and disposable lids, it is also desirable to produce such lids capable of degrading more rapidly than currently known.

### SUMMARY OF THE INVENTION

The present application is directed to a beverage container lid comprising a polymeric material and a pro-degradant additive in an amount from about 0.5% to about 5.0% by weight of the lid.

The present application is also directed to a single-use beverage container lid formed from an extrusion comprising a degradable thermoplastic and an amount of a pro-degradant additive effective to reduce the molecular mass of the thermoplastic by about 86 percent absent a biologically active environment.

The present application is also directed to a process for forming a degradable beverage container lid comprising the following steps: (1) producing a first extruded sheet material comprising (a) a virgin polymeric material, and (b) a pro-degradant additive in an amount from about 0.5% to about 5.0% by weight of the sheet material; (2) forming one or more beverage container lids from the extruded sheet material resulting in an amount of unused sheet material; (3) recycling the unused sheet material back into the extrusion process as regrind; and (4) forming a second extruded sheet material infused with an amount of the regrind.

The present application is also directed to a process for forming a functional degradable beverage container lid operationally configured to degrade within four years of lid formation comprising forming the lid from a composition comprising a polymeric material and a pro-degradant additive in an amount effective to lower the molecular weight of the polymeric material by about eighty-six (86) percent over said four year period.

### BRIEF DESCRIPTION OF THE DRAWINGS

FIG. 1A is a perspective view of an embodiment of the present beverage container lid.

FIG. 1B is a representation of the beverage container lid following degradation.

FIG. 2 is a side view of a beverage container and corresponding lid.

FIG. 3 is a cross-sectional view of a two layer lid.

FIG. 4 is a cross-sectional view of a three layer lid.

FIG. 5 is a cross-sectional view of a four layer lid.

### DETAILED DESCRIPTION OF THE PREFERRED EMBODIMENTS

It has been discovered that a single-use and/or disposable beverage container lid constructed from known polymeric materials may be operationally configured to provide for the rapid degradation or breakdown of the polymeric material from which the lid is constructed. Heretofore, such a desirable achievement has not been considered possible, and accordingly, the beverage container lid and process of this application measure up to the dignity of patentability and therefore represents a patentable concept.

Before describing the invention in detail, it is to be understood that the present invention is not limited to particular embodiments. It is also to be understood that the terminology used herein is for the purpose of describing particular embodiments only, and is not intended to be limiting. As used in this specification and the appended claims, the terms “single-use lid” and “disposable lid” may be used interchangeably. A “functional single-use beverage container lid” or “functional lid” refers to a beverage lid operationally configured to provide structural strength and rigidness during use, including when exposed to temperatures up to about 230° F. (about 110° C.), moisture, physical impact, stresses, and combinations thereof. The term “degrade” and variants thereof, as used through the specification means that significant physical and/or chemical change has occurred with respect to the single-use beverage container lid. The term “regrind” means offcut or leftover extruded sheet material occurring during lid production that is fed back to the extrusion process. Suitably, regrind is gained from preceding manufacturing runs of the same or similar product. The phrase “accelerated time frame” refers to the quickened degradation time of a beverage container lid relative to conventional plastic materials. The term “extrusion” and like terms refers to commercially available techniques related to producing usable polymeric materials. For example, one type of extruder is equipped to melt the polymeric material and force it through an exit die to produce a thin polymeric sheet material.

In one aspect, the application provides a single-use beverage container lid effective for use with paper, board, foam or plastic cups as related to the sale of hot and cold liquid beverages, such as soft drinks, coffee, tea, cocoa, and the like.

In another aspect, the application provides an oxy-degradable single-use beverage container lid.

In another aspect, the application provides a single-use beverage container lid constructed from a conventional plastic and comprising one or more pro-degradant materials effective to degrade the plastic to form water, oxygen and a small amount of biomass. The present beverage container lid is suitable for use in connection with beverages of temperatures up to about 230° F. (about 110° C.). In other words, the beverage container lid is functional when exposed to temperatures up to about 230° F. (about 110° C.).

In another aspect, the application provides a single-use beverage container lid constructed from a conventional plastic and comprising oxy-degrading materials effective to trigger a degrading effect of the plastic material at a pre-determined time following extrusion of the lid material during manufacturing, and in the event the lid is exposed to elements such as water, ultra-violet light, and mechanical stress, the degrading ability of the oxy-degrading materials is enhanced.

In another aspect, the application provides a single-use beverage container lid constructed from a polymeric material including regions of the lid necessarily including a pro-degradant and regions of the lid not including any pro-degradant.

In another aspect, the application provides a single-use beverage container lid whereby a pro-degradant is introduced into a polymer based lid as a catalyst effective to cause the rapid breakdown of the polymer.

In another aspect, the application provides a single-use beverage container lid constructed from one or more plastics and one or more pro-degradant additives.

In another aspect, the application provides a single-use beverage container lid constructed from (a) a starting constituency of one or more plastics and one or more pro-degradant additives, and (b) regrind physically blended with the starting constituency.

In another aspect, the application provides an additive material that can trigger polymeric composition degradation by merely mixing the additive in with the polymeric material any time before the polymeric material is formed into a beverage container lid.

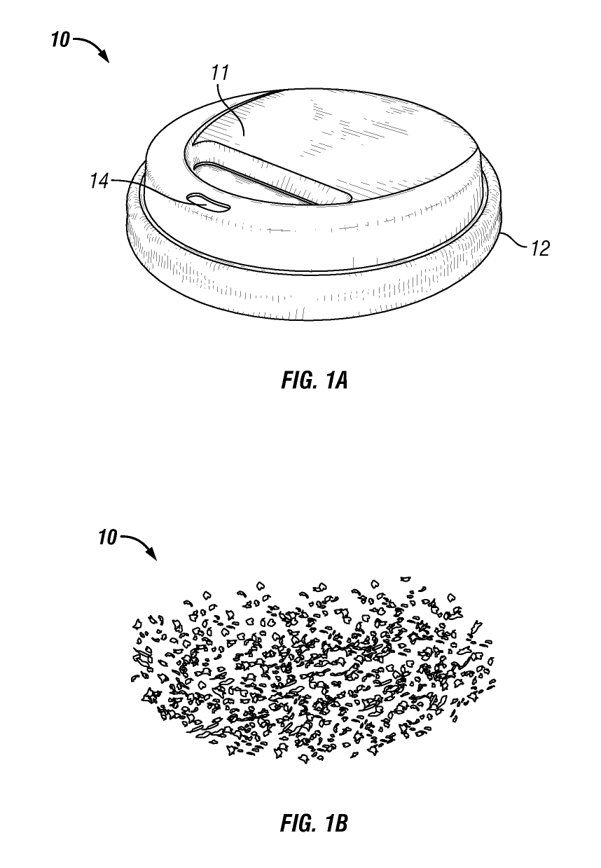

FIGS. 1A and 1B depict a simplified illustration of a present single-use beverage container lid 10 in a functional state and a degraded state later in time. As found with known lids used in conjunction with containers for the transportation and consumption of beverages (both hot and cold), the present lid 10 suitably includes a deck 11, a peripheral skirt 12 for sealingly engaging the container, and at least one drink through aperture 14 operationally configured to allow liquid to pass there through.

The present lid 10 may also comprise a partially separable, preformed tab (not shown) in the deck 11 to form a drink-through aperture which does not extend through the peripheral skirt 12.

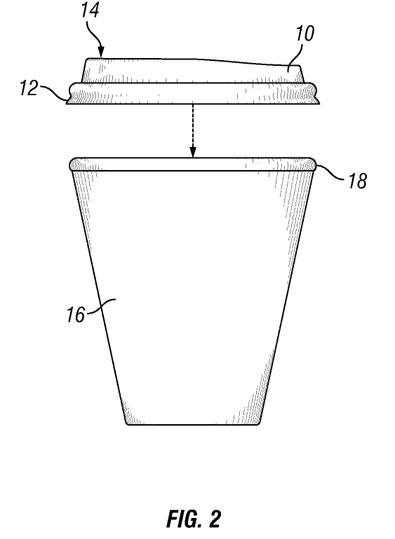

Commercially, the construction, shape and design of beverage container lids are well known. Thus, the present lid 10 may be formed in one of many other configurations suitable for sealable engagement with various commercially available beverage containers. As shown in FIG. 1A, the lid 10 may be substantially circular. In another embodiment, the lid 10 may be multi-sided. Referring to FIG. 2, in a particularly advantageous embodiment the skirt 12 suitably is operationally configured to seal to a container 16 along the container rim 18 in a manner effective to prevent any contained liquid from passing between the skirt 12 and rim 18.

Seeing that the sealing integrity between a single-use lid 10 and its corresponding beverage container 16 is a substantial safety concern, e.g., during consumption and/or transport of beverages including hot beverages, it is preferable that the present beverage container lid 10 be constructed from one or more known polymeric materials having properties capable of maintaining lid structural strength and rigidness when exposed to high temperature and/or moisture. Thus, a novel feature of the present invention includes maintaining the use of known polymeric lid 10 materials while also accelerating the time frame for degradation of such polymeric materials. Suitably, the one or more polymeric lid 10 materials degrade at an accelerated rate into one or more end products including at least water, oxygen, small amounts of biomass, and combinations thereof.

Without limiting the invention, suitable polymeric lid 10 materials include conventional thermoplastics commercially available at the time of this application. Apposite lid 10 thermoplastics include, but are not necessarily limited to high impact polystyrene, polyethylene, polypropylene, and combinations thereof. Many other degradable materials may be used as determined by those knowledgeable in the field of the invention including, but not necessarily limited to naturally occurring polymers and synthetic aliphatic polyesters.

Typically, the above listed thermoplastics are not regarded as degradable. The properties that make these polymers resilient and attractive as a packaging medium, e.g., strength, flexibility, water resistance, and air resistance, are the result of their molecular structures. Such polymers are hydrocarbons, meaning their molecular backbones are constructed of hydrogen atoms bonded together by carbon atoms in long entangled chains. It is these long chains that provide strength, flexibility, water resistance, and air resistance, but also significantly prevent oxygen from attaching to the carbon and hydrogen atoms that would otherwise trigger oxidation leading to degradation.

Large molecular mass polymers such as those listed above eventually do degrade through oxidation and then bio-degradation but the process typically takes decades of exposure to heat and/or light slowly breaking down the polymer molecular chains. Additives may be added to the above mentioned polymeric materials to trigger an accelerated bio-degrading effect of the polymeric material, but the polymeric material requires exposure to one or more elements such as water, ultra-violet light (“UV”), mechanical stress, and aerobic environments such as composting and litter, in order to trigger an accelerated rate of degradation. For example, under the current “ASTM 6400-04 Standard Specification for Compostable Plastics” those plastics deemed “biodegradable” must achieve sixty percent (60%) biodegradation within 180 days under specified composting conditions. A novel feature of the present lid 10 is its ability to degrade absent exposure to the above-listed elements. In other words, the pro-degradant additives of the present invention are effective for accelerating the degradation time frame of polymeric materials of the lid 10 without any necessary exposure to the above-listed elements. In a particularly advantageous embodiment, the pro-degradant additives of the present invention are effective for accelerating the degradation time frame of polymeric materials of a lid 10 upon exposure to only oxygen.

For example, the molecular mass of a typical polyethylene is about 300,000 u. By introducing a pro-degradant material into the polyethylene, the long molecular chains of the polyethylene may be reduced in size permitting oxygen to bond with the carbon to produce CO₂. In such scenario, the molecular mass of polyethylene quickly descends to below 40,000 u and at such stage the polyethylene material effectively becomes water wettable and micro-organisms can access the carbon and hydrogen. Carbon that is used for cell wall structure is eventually exhausted as CO₂ and hydrogen as H₂O—a stage that can accurately be described as bio-degradation. Depending on the type and/or amount of pro-degradant material introduced into the polyethylene, the plastic beverage lid 10 may begin degrading during the extrusion stage or at a predetermined time following extrusion. In either case, the polyethylene based lid 10 suitably becomes brittle eventually disintegrating into tiny flakes (see FIG. 1A) at a much more rapid rate than otherwise achievable.

To attain desired lid 10 degradation, the polymeric lid materials) are suitably physically blended with one or more pro-degradant additives during the extrusion process. Depending on the polymeric material and pro-degradant additive used, the degradation process may be initiated at the time the polymeric material is being extruded or following extrusion. Regardless of the desired degradation rate, one or more pro-degradant additives are suitably provided as a masterbatch thereafter functioning to break down the carbon-carbon bonds in the polymeric material leading to a lowering of the molecular weight and eventually to a loss of strength and other properties of the lid 10. In addition, stabilizers may be further added during extrusion to ensure that a sufficiently long useful life is provided depending on the specific lid 10 application. Suitably, the accelerated time frame for degradation is triggered during extrusion of the lid 10 materials, but is sufficiently slow during the initial stages of the scission to have no negative effect on the properties of the lid 10 during commercial use thereof. In addition, the overall degradation process may be delayed if the lid 10 is subjected to chilling or freezing. On the other hand, the overall degradation process may be accelerated if the lid 10 is subjected to sustained periods of UV, heat, mechanical stress such as stretching and tearing, and combinations thereof. It is also contemplated that a lid 10 product may be packaged or otherwise marked in a manner to inform a user of the expected shelf life of the lid 10. For example, a particular lid 10 product may be marked by recommending that the lid 10 be used by a particular calendar date.

Typically, only small amounts of the pro-degradant additives are required to cause a suitable degradation reaction. The amount of pro-degradant additive to be introduced into any one polymeric based product may differ depending on one or more factors including for example, (1) the polymer material used, (2) the desired rate of degradation, (3) the intended use of the lid 10, and (4) the amount of regrind to be used in succeeding runs. For the purposes of this application, the pro-degradant additive is introduced in an amount effective to degrade the polymeric material in a time frame ranging from about six months to about four years from extrusion. In one embodiment, a suitable lid 10 is comprised of from about 0.5% to about 5.0% by weight pro-degradant additive. In another embodiment, the lid 10 is comprised of from about 1.0% to about 3.0% by weight pro-degradant additive. In a particularly advantageous embodiment including a lid 10 operationally configured to degrade in about one year's time following extrusion, the lid 10 comprises about 1.0% by weight of pro-degradant additive.

In one aspect, suitable degradable additives may include one or more oxy-degradable additives effective for degrading polymeric materials at an accelerated rate. Suitable degradable additives include transition metal salts. Suitable transition metal salts include manganese, iron, cobalt and nickel. In one mode of suitable operation, a pro-degradant metal salt is effective to cause a breakdown of the carbon-carbon bonds in a given thermoplastic's molecular chains—i.e. chain cleavage, or scission activation, leading to a lowering of the molecular weight and eventually to a loss of structural strength and other properties of the lid 10. Suitably, the molecular mass of the thermoplastic comprising a lid 10 is reduced by about eighty-six percent (86%) in a time frame ranging from about six months to about four years from extrusion.

In addition to the type and/or amount of pro-degradant additive used, the rate of degradation may also be influenced by the actual configuration of the lid 10—as formed during the extrusion process. In particular, the extrusion process may be operationally configured to provide a selective lid 10 having a desired distribution of both polymeric material and pro-degradant additive throughout. In detail, the extrusion process suitably provides extruded sheet material comprising the desired polymeric material and pro-degradant additive concentrations through out. Individual lids 10 are then cut out from the extruded sheet material to form the desired lid 10 configuration via vacuum thermoforming or other recognized technique. Thus, the particular arrangement and constituency of polymeric material and pro-degradant additive within the extruded sheet material governs the particular arrangement and constituency of polymeric material and pro-degradant additive found in a particular lid 10 product.

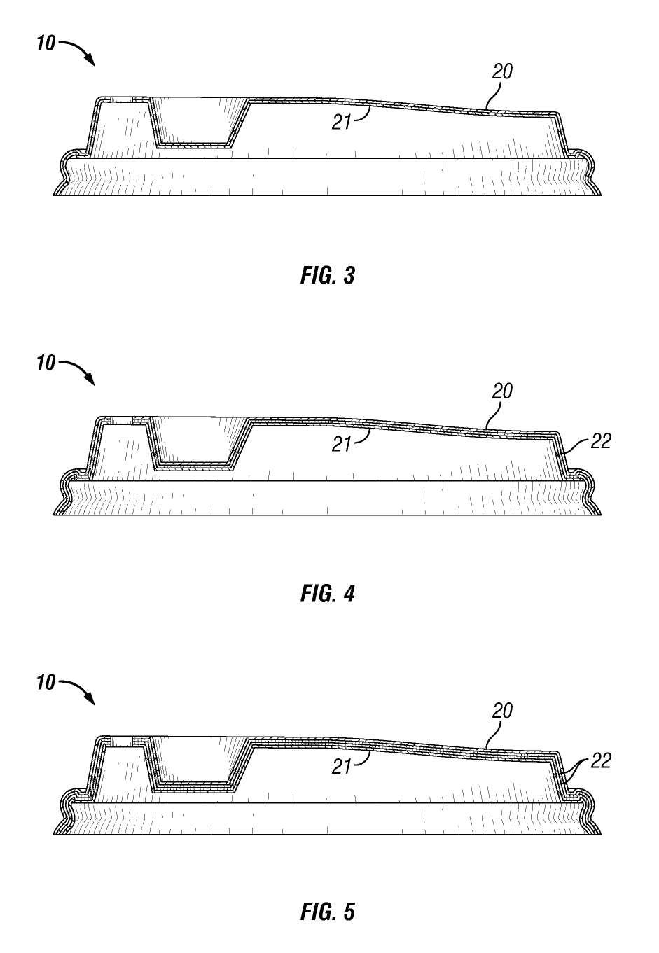

In one suitable embodiment, the extruded sheet material and lid 10 originating there from may include a solid one piece polymeric material further comprising pro-degradant additive evenly infused throughout. In another simplified embodiment, the extruded sheet material may be formed from multiple layers of polymeric material comprising pro-degradant additive evenly infused throughout. Referring to the simplified embodiment of FIG. 3, one suitable lid 10 may be formed from a co-extruded sheet material including an upper layer 20 and a lower layer 21. As shown in the embodiment of FIG. 4, another suitable lid 10 may be formed from a tri-extruded sheet material having an upper layer 20, a lower layer 21, and an inner layer 22. In yet another embodiment as shown in FIG. 5, a suitable lid 10 may be formed from a multiple-extruded sheet material having upper layer 20, a lower layer 21, and a plurality of inner layers sandwiched between the upper layer 20 and lower layer 21.

In one suitable embodiment, the extruded sheet material and lid(s) 10 formed there from may be comprised of multiple layers with pro-degradant additive evenly infused throughout each layer. In another embodiment, the extruded sheet material and lid(s) 10 formed there from may be comprised of multiple layers including a pro-degradant additive that is unevenly infused throughout each layer. In an embodiment where the extruded sheet material and lid(s) 10 formed there from comprise three or more layers, at least two layers may include pro-degradant additive evenly infused throughout each layer, while the remaining layer(s) may comprise pro-degradant additive unevenly infused throughout. In another embodiment where the extruded sheet material and lid(s) 10 formed there from comprise three or more layers, at least two layers may include pro-degradant additive unevenly infused throughout each layer, while the remaining layer(s) may include pro-degradant additive unevenly infused throughout. In another embodiment, an upper layer 20 of the lid 10 may include pro-degradant additive evenly infused throughout while the lower layer 21 includes pro-degradant additive unevenly infused throughout, or vice versa. In another embodiment, the upper layer 20 may comprise a pro-degradant additive while the lower layer 21 comprises no pro-degradant additive, and vice versa. In addition, pro-degradant additive may be infused into one or more layers at specific locations, or infused in higher concentrations at specific locations within the extruded sheet material than at other locations.

Commercially available beverage container lids, such as plastic soft drink and coffee lids comprise thicknesses of about 1.0 mm or less, depending on the intended use. Suitably, the present lid 10 comprises substantially similar thicknesses to commercially comparable lids. In one embodiment of the lid 10 comprising layers, the layers are provided with substantially equal thicknesses through out. In another embodiment, the lid 10 layers comprise different thicknesses. In another embodiment comprising three or more lid 10 layers, at least two layers comprise substantially equal thicknesses. Suitably, no one layer comprises a thickness greater than about 95% of the total thickness of the lid 10, although greater thicknesses may be obtained as desired. Since the present lid 10 may be built to scale, it is further contemplated that extruded sheets and lids 10 formed there from may include thicknesses greater than 1.0 mm depending on the commercial application of the lid 10.

The above examples are representative only and not meant to limit the invention, whereby the extruded sheet material and lid 10 formed there from may include any number of layers, each layer having (1) any desired ratio of polymeric material to pro-degradant additive, suitably from 0% up to about 5% by weight of pro-degradant additive per layer; and (2) any desired thickness relative to the thickness of the extruded sheet or lid 10 material.

In one embodiment, the extruded sheet material and lids 10 formed there from may be constructed from virgin polymeric material infused with pro-degradant additive. Thereafter, extruded sheet material and lid(s) 10 formed there from may be constructed from (1) regrind, (2) a combination of virgin polymeric material and regrind, or (3) a combination of virgin polymeric material infused with pro-degradant and regrind. Suitably, the regrind is mechanically shredded before being introduced back into the extrusion process where the extruded sheet material is thermo-formed to provide desired extruded sheet material for future lid 10 formation.

It is generally accepted by those of ordinary skill in the art that thermoplastic regrind does not significantly compromise the physical properties of the resulting product where the regrind is maintained at levels less than about 25% by weight of the intended product. Thermoplastic regrind levels exceeding 25% by weight of the intended product may adversely reduce the molecular weight of a product in comparison to a virgin product—resulting in the deterioration of the mechanical properties of the product including loss of strength, clarity, resistance and flexibility. A degradation of the key properties of a virgin material will magnify in direct proportion to the increase of the percentage of regrind used. By implementing the previously discussed layering including one or more pro-degradant additives at the above mentioned ranges, the adverse effects of using regrind, including deterioration of the mechanical properties of a lid product, may be overcome.

As stated previously, it is preferable that the lid 10 be constructed from one or more materials having properties (1) effective for maintaining lid 10 structural strength and rigidness when exposed to high temperature and/or moisture, and (2) effective for degrading the lid 10 in an accelerated time frame. Thus, the amount of regrind to be used in producing a particular lid 10 may be determined by the intended commercial use of the lid 10. In one suitable embodiment of the lid 10 comprising an upper layer 20 and a lower layer 21 (see FIG. 3) each layer may comprise regrind in a desired amount—one layer comprising more or less than the other layer. In another embodiment, the upper layer 20 and the lower layer 21 may comprise substantially the same amount of regrind. In one embodiment of the lid 10 comprising three layers (see FIG. 4), only the lower layer 21 includes regrind in a desired amount. In another embodiment of the lid 10 comprising three layers, only the inner layer 22 includes regrind in a desired amount. In still another embodiment of the lid 10 comprising three layers, only the upper layer 20 includes a desired amount of regrind. In still another embodiment, regrind may be included in any two layers in substantially similar or different amounts as desired. In like manner, a lid 10 comprising four or more layers (see FIG. 5) may include an amount of regrind in one or more layers as desired—the regrind including layers having (1) substantially similar amounts of regrind, (2) differing amounts of regrind, or (3) some layers having substantially similar amount of regrind compared to the remaining layers.

Suitably, lids 10 comprising regrind are at least about 25% by weight regrind material. In another embodiment, about 50% or more of the lid 10 by weight may be regrind material regardless of the percentage of regrind incorporated into any one particular layer or combination of layers.

As shown, the present lid 10 may be formed from extruded sheet material having any number of layers including varying amounts of regrind amongst the layers in order to provide a lid 10 suitable for a particular commercial application. It should also be noted that the amount of regrind to produce a particular lid 10 may be determined by one or more of the following: (1) the percentage of pro-degradant by weight in the regrind, (2) the percentage of pro-degradant by weight in the virgin polymeric material to be thermo-formed with a particular regrind, and (3) the intended commercial use of the lid 10.

Persons of ordinary skill in the art will recognize that many modifications may be made to the present application without departing from the spirit and scope of the application. The embodiment(s) described herein are meant to be illustrative only and should not be taken as limiting the invention, which is defined in the claims.

I claim:

1. A beverage container lid comprising:
a polymeric material; and
a pro-degradant additive in an amount from about 0.5% to about 5.0% by weight of the lid.

2. The lid of claim 1, wherein about 25% or more of the lid by weight is comprised of regrind comprising (a) a polymeric material, and (b) a pro-degradant additive in an amount from about 0.5% to about 5.0% by weight of the regrind.

3. The lid of claim 1, wherein the lid comprises a plurality of layers including at least an outer upper surface layer and an outer lower surface layer.

4. The lid of claim 3, wherein at least one layer comprises an amount of regrind comprising (a) a polymeric material, and (b) a pro-degradant additive in an amount from about 0.5% to about 5.0% by weight.

5. The lid of claim 4, wherein the lid is comprised of about 25% or more by weight of regrind.

6. The lid of claim 4, wherein the lid is comprised of about 50% or more by weight of regrind.

7. The lid of claim 6, wherein no one layer comprises any more than about 25% by weight of regrind.

8. The lid of claim 1, wherein the lid is formed from an extruded sheet material comprising the pro-degradant additive.

9. The lid of claim 3, wherein the lid is formed from an extruded sheet material comprising the pro-degradant additive.

10. The lid of claim 4, wherein at least two layers comprise an amount of regrind comprising (a) a polymeric material, and (b) a pro-degradant additive in an amount from about 0.5% to about 5.0% by weight.

11. The lid of claim 1, wherein the polymeric material includes a thermoplastic.

12. The lid of claim 2, wherein the polymeric material includes a thermoplastic.

13. The lid of claim 11, wherein the thermoplastic is selected from the group consisting of high impact polystyrene, polyethylene, polypropylene, and combinations thereof.

14. The lid of claim 12, wherein the thermoplastic is selected from the group consisting of high impact polystyrene, polyethylene, polypropylene, and combinations thereof.

15. The lid of claim 1, wherein the pro-degradant additive is a transition metal salt.

16. The lid of claim 2, wherein the pro-degradant additive is a transition metal salt.

17. The lid of claim 1 including about 1.0% by weight of pro-degradant additive.

18. The lid of claim 8, wherein the degradation process is initiated during extrusion of the sheet material.

19. The lid of claim 8, wherein the degradation process is initiated about six months to about four years following extrusion of the sheet material.

20. A single-use beverage container lid formed from an extrusion comprising a degradable thermoplastic and an amount of a pro-degradant additive effective to reduce the molecular mass of the thermoplastic by about 86 percent absent a biologically active environment.

21. The lid of claim 20, wherein the molecular mass of the thermoplastic is reduced by about eighty-six (86) percent in a period from about six months to about four years following extrusion.

22. The lid of claim 21, wherein the thermoplastic is degraded to form water, oxygen and a small amount of biomass.

23. A process for forming a functional degradable beverage container lid operationally configured to degrade within four years of lid formation comprising forming the lid from a composition comprising a polymeric material and a pro-degradant additive in an amount effective to lower the molecular weight of the polymeric material by about eighty-six (86) percent over said four year period.

24. A process for forming a degradable beverage container lid comprising the following steps:
producing a first extruded sheet material comprising (a) a virgin polymeric material, and (b) a pro-degradant additive in an amount from about 0.5% to about 5.0% by weight of the sheet material;
forming one or more beverage container lids from the extruded sheet material resulting in an amount of unused sheet material;
recycling the unused sheet material back into the extrusion process as regrind; and
forming a second extruded sheet material infused with an amount of the regrind.

25. The process of claim 24, whereby the second extruded sheet comprises one or more layers with at least one layer being infused with an amount of the regrind.
